(19) United States
(12) Patent Application Publication
(10) Pub. No.: US 2007/0096479 A1
(43) Pub. Date: May 3, 2007

(54) Positioning structure for a door lock mechanism

(75) Inventors: Chun-Cheng Lin, Kang-Shan Chen (TW); Mei-Kuei Lee, Kang-Shan Chen (TW)

Correspondence Address: NIKOLAI & MERSEREAU, P.A., 900 SECOND AVENUE SOUTH, SUITE 820, MINNEAPOLIS, MN, 55402, US

(73) Assignee: Taiwan Fu Hsing Industrial Co., Ltd., Kaohsiung Hsien (TW)

(21) Appl. No.: 11/259,783

(22) Filed: Oct. 27, 2005

(51) Int. Cl. E05B 3/00

(52) U.S. Cl. 292/336.3

(57) ABSTRACT

A door lock mechanism includes a latch bolt actuating unit, an inner lever assembly, an outer lever assembly and at least two screw members. The latch bolt actuating unit is received in a lock bore of a door plank. In assembling, the inner lever assembly and the outer lever assembly connect with either side of the latch bolt actuating unit, respectively. One of the inner lever assembly and the outer lever assembly provides a reinforcing rose liner on which to provide at least two screw holes for screw-connection with the screw members. In installing operation, the screw members are engaged in the screw holes of the reinforcing liner, and then directly engaged on and slightly inserted into a surface of the door plank. Accordingly, the reinforcing liner securely mounts the lever assembly on the door plank when installed.

### BACKGROUND OF THE INVENTION

1. Field of the Invention

The present invention relates to a positioning structure for a door lock mechanism. Particularly, the present invention relates to the positioning structure for mounting the door lock mechanism on a door plank. More particularly, the present invention relates to the positioning structure employing a reinforcing rose liner and two screw members for mounting the door lock mechanism on the door plank.

2. Description of the Related Art

U.S. Pat. No. 6,619,710, entitled “ADJUSTABLE LOCK FOR VARIOUS DOOR THICKNESSES,” discloses a cylindrical lock assembly including a lock chassis, an inner tubular member and an outer tubular member. In assembling, the inner tubular member and the outer tubular member connect with either side of the lock chassis. Each of the inner tubular member and the outer tubular member provides with a threaded portion. The inner tubular member can be combined with an inner handle assembly while the outer tubular member can be combined with an outer handle assembly.

The outer handle assembly includes an outer mounting rose and an outer rose liner between which to sandwich a mounting ring and an adjusting gear. In adjusting operation, the adjusting gear can actuate the mounting ring to turn about a longitudinal line for reciprocation with respect to the lock chassis. The mounting ring has a threaded portion running on that of the outer tubular member so that a distance of the outer handle assemble (without assembling an outer handle) relative to the lock chassis is adjusted in assembling operation. The outer handle assembly further includes a pair of guiding posts and the inner handle assembly correspondingly includes a pair of screw members. Each distal end of the guiding posts provides with a screw hole adapted to receive the screw member for screw connection such that the outer handle assembly and the inner handle assembly are mounted to either side of a door plank. Furthermore, the lock chassis can be disposed between the outer handle assembly and the inner handle assembly, and can thus be installed in a lock bore of the door plank.

Additionally, the lock chassis includes a pair of detachable rods and a pair of screw members. Each first end of the detachable rods is extended through an aperture of the outer rose liner, and subsequently screw-connected with a screw hole of the outer mounting rose. Accordingly, the detachable rods securely mount the outer rose liner on the outer mounting rose. Each second first end of the detachable rods is provided with a screw hole. The screw members successively extend through assembling holes of an inner mounting rose and an inner rose liner of the inner handle assembly, and screw-connects with the screw holes of the detachable rods in the event. Meanwhile, each combination of the detachable rod with the screw member is positioned in a positioning hole of the door plank. Generally, all of the positioning holes are disposed on a peripheral edge of the lock bore of the door plank, and arranged to connect between the two sides of the door plank. Concretely, the detachable rods and the screw members are connected each other within the corresponding positioning holes of the door plank.

The positioning structure of the cylindrical lock assembly disclosed in U.S. Pat. No. 6,619,710 can, however, avoid occurrences of displacement, rotational movements and vibrations of the lock chassis in operation when installed. Even though this ensures a certain extent of reliability of the assembled relationship of the cylindrical lock assembly and is easy to assembly or disassembly of the cylindrical lock assembly, a number of design limitations exist for the cylindrical lock assembly due to difficulties in installation. For example, this practice naturally necessitates prefabrication of the positioning holes of the door plank in place. Additionally, another problem with the door plank (e.g. metal door plank) without providing positioning holes is difficulty in installing the inner mounting rose and the inner rose liner of the inner handle assembly. Also, the inner rose liner has an ordinary or common form of a thickness through which no screw holes can be drilled. When this occurs, the inner mounting rose and the inner rose liner of the inner handle assembly can be mounted to the lock chassis only by means of the assembled relationship of the guiding posts and the screw members; namely, the inner mounting rose and the inner rose liner of the inner handle assembly have no other means to be mounted to the lock chassis. Such practice may, however, cause relative reduction of the reliability of the assembled relationship of the cylindrical lock assembly. Hence, there is a need for improving the positioning structure of the cylindrical lock assembly in case of installation.

The present invention intends to provide a positioning structure for a door lock mechanism having at least one reinforcing liner on which to provide at least two screw holes for screw-connection with screw members. In installing operation, the reinforcing liner can be securely mounted on a surface of a door plank by means of the screw members in such a way as to mitigate and overcome the above problem. Accordingly, this ensures an increase of reliability of the assembled relationship of the door lock mechanism and is easy to assembly or disassembly of the door lock mechanism.

### SUMMARY OF THE INVENTION

The primary objective of this invention is to provide a positioning structure for a door lock mechanism, wherein a reinforcing rose liner provides at least two screw holes for screw-connection with screw members. In installing operation, the reinforcing liner can be securely mounted on a surface of a door plank by engaging the screw members in the screw holes. Accordingly, this ensures an increase of reliability of the assembled relationship of the door lock mechanism and is easy to assembly or disassembly of the door lock mechanism.

The secondary objective of this invention is to provide the positioning structure for the door lock mechanism, wherein a reinforcing rose liner provides at least two screw holes for screw-connection with screw members. In installing operation, the screw members are engaged in the screw holes of the reinforcing liner, and further extended through auxiliary positioning holes of a door plank. Accordingly, this ensures an increase of reliability of the assembled relationship of the door lock mechanism and is easy to assembly or disassembly of the door lock mechanism.

The door lock mechanism in accordance with an aspect of the present invention includes a latch bolt actuating unit, an inner lever assembly, an outer lever assembly and at least two screw members. The latch bolt actuating unit is received in a lock bore of a door plank. In assembling, the inner lever assembly and the outer lever assembly connect with either side of the latch bolt actuating unit, respectively. One of the inner lever assembly and the outer lever assembly provides a reinforcing rose liner on which to provide at least two screw holes for screw-connection with the screw members. In installing operation, the screw members are engaged in the screw holes of the reinforcing liner, and then directly engaged on and slightly inserted into a surface of the door plank. Accordingly, the reinforcing liner securely mounts the lever assembly on the door plank when installed.

In a separate aspect of the present invention, the door plank provides at least two auxiliary positioning holes through which predetermined lengths of the screw members are extended.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded perspective view of a positioning structure for a door lock mechanism in accordance with a first embodiment of the present invention;

FIG. 2 is a fragmental cross-sectional view of the positioning structure for the door lock mechanism in accordance with the first embodiment of the present invention;

FIG. 3 is an exploded perspective view of a positioning structure for a door lock mechanism in accordance with a second embodiment of the present invention; and

FIG. 4 is a fragmental cross-sectional view of the positioning structure for the door lock mechanism in accordance with the second embodiment of the present invention.

### DETAILED DESCRIPTION OF THE INVENTION

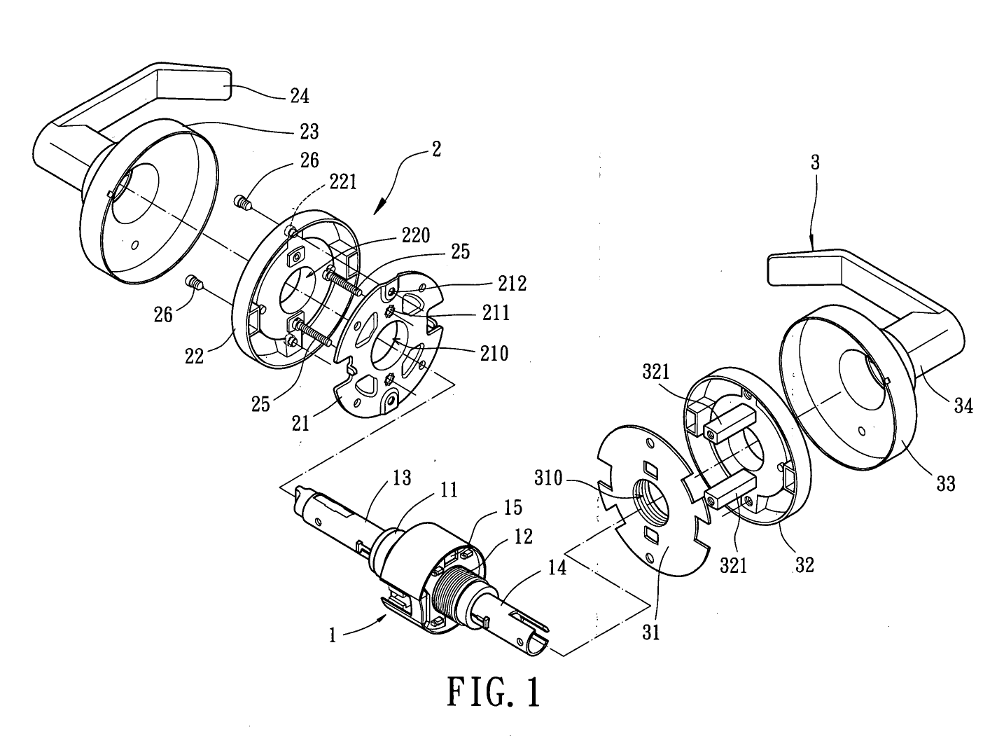

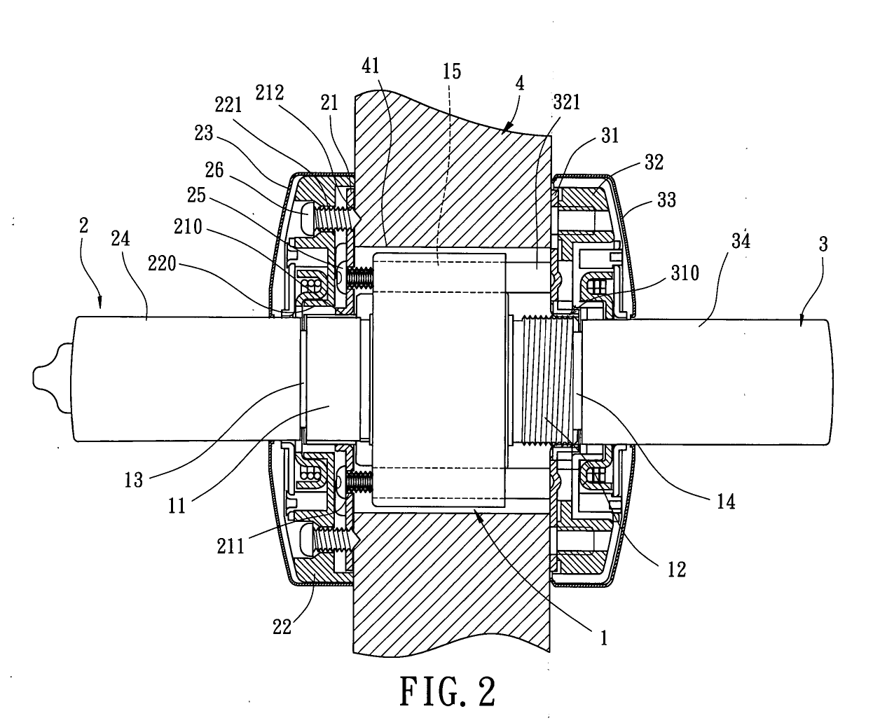

Referring now to FIGS. 1 and 2, views of a positioning structure for a door lock mechanism in accordance with a first embodiment of the present invention are illustrated and may be installed on a door plank (not shown in FIG. 1). In the first embodiment, the door lock mechanism generally includes a latch bolt actuating unit designated numeral 1, an inner lever assembly (i.e. first lever assembly) designated numeral 2 and an outer lever assembly (i.e. second lever assembly) designated numeral 3.

Still referring to FIGS. 1 and 2, constructions of the latch bolt actuating unit 1 shall be described in detail. Typically, the latch bolt actuating unit 1 includes an inner tubular member 11, an outer tubular member 12, an inner driving tubular member 13, an outer driving tubular member 14 and a pair of through holes 15. The inner tubular member 11 and the outer tubular member 12 are combined with either side of the latch bolt actuating unit 1, respectively. In a preferred embodiment, the outer tubular member 12 is provided with an outer threaded portion for screw-connection with the outer lever assembly 3; a length of the outer threaded portion of the outer tubular member 12 can be adjusted according to a thickness of a door plank 4, as best shown in FIG. 2. Each of the inner driving tubular member 13 and the outer driving tubular member 14 is correspondingly pivot-connected with each of the inner tubular member 11 and the outer tubular member 12. In locking or unlocking operation, both of the inner driving tubular member 13 and the outer driving tubular member 14 can be turned with respect to the latch bolt actuating unit 1 so that they can actuate the latch bolt actuating unit 1 to retract a latch bolt set (not shown). The through holes 15 can connect between the two sides of the latch bolt actuating unit 1 for assembling the inner lever assembly 2 and the outer lever assembly 3. In an alternative embodiment, the inner tubular member 11 is provided with an outer threaded portion for screw-connection with the inner lever assembly 2; as length of the outer threaded portion of the inner tubular member 11 can be adjusted according to a thickness of the door plank 4.

Still referring to FIGS. 1 and 2, constructions of the inner lever assembly 2 shall be described in detail. Generally, the inner lever assembly 2 includes a reinforcing rose liner 21, an inner mounting rose 22, an inner rose escutcheon 23, an inner lever 24, at least two first screw members 25 and at least two second screw members 26. In the preferred embodiment, the reinforcing rose liner 21 has an axial hole 210, at least two holes 211 and at least two screw holes 212. The inner tubular member 11 extends through the axial hole 210 of the reinforcing rose liner 21. The first screw members 25 correspondingly extend through the holes 211 of the reinforcing rose liner 21. In the first embodiment, each of the screw holes 212 is provided with an inner threaded portion, as best shown in FIG. 2, for screw-connection with the second screw member 26 or fastener.

By referring again to FIG. 1; the inner mounting rose 22 has an axial hole 220 and a pair of through hole 221. In the preferred embodiment the inner tubular member 11 further extends through the axial hole 220 of the inner mounting rose 22. The second screw members 26 correspondingly extend through the holes 221 of the inner mounting rose 22. The inner rose escutcheon 23 covers the inner mounting rose 22 while the inner mounting rose 22 mounts the reinforcing rose liner 21 by means of the second screw members 26. In the first embodiment, the first screw members 25 and the second screw members 26 are preferably constructed from ordinary screws. In a preferred embodiment, the second screw member 26 has a distal sharpened tip to engage with the surface of the door plank 4. Preferably, the second screw member 26 is processed in a procedure of carburizing, quenching or both. Consequently, the second screw member 26 has a high degree of rigidity to withstand the hardness of materials, such as woods or metals, of the door plank 4.

Still referring to FIG. 1, constructions of the outer lever assembly 3 shall be described in detail. In the preferred embodiment, the outer lever assembly 3 includes a reinforcing rose liner 31, an outer mounting rose 32, at least two assembling posts 321, an outer rose escutcheon 33 and an outer lever 34. In the preferred embodiment, the reinforcing rose liner 31 has an axial hole 310 in which to provide an inner threaded portion to mate with the outer threaded portion of the outer tubular member 12 of the latch bolt actuating unit 1. In an alternative embodiment, the assembling post 321 can be integrally or separately formed on a surface of the outer mounting rose 32. The assembling posts 321 correspondingly extend through holes (unlabeled) of the reinforcing rose liner 31. Each distal end of the assembling posts 321 is provided with a screw bore which faces a direction to the inner lever assembly 2. In the following step of assembling operation, the first screw members 25 of the inner lever assembly 2 are correspondingly engaged with threaded portions of the screw holes of the assembling posts 321.

Referring again to FIGS. 1 and 2, installing operation of the door lock mechanism shall be described in detail. In the first embodiment, the latch bolt actuating unit 1 is inserted into a lock bore 41 of the door plank 4, as shown in FIG. 2. The latch bolt set (not shown) of the door lock mechanism is inserted into a latch bore (not shown) of the door plank communicating with the lock bore 41 so that the latch bolt set is mechanically connected with the latch bolt actuating unit 1. The outer tubular member 12 of the latch bolt actuating unit 1 extends through the axial hole 310 of the reinforcing rose liner 31 on an outer side of the door plank 4. Subsequently, the inner threaded portion of the reinforcing rose liner 31 can be connected with the outer threaded portion of the outer tubular member 12 of the latch bolt actuating unit 1, and a position of the reinforcing rose liner 31 can be thus adjusted on the outer tubular member 12 according to the thickness of the door plank 4. The assembling posts 321 of the outer mounting rose 32 successively extend through holes of the reinforcing rose liner 31 and the through holes 15 of the latch bolt actuating unit 1. Correspondingly, the inner tubular member 11 of the latch bolt actuating unit 1 extends through the axial hole 210 of the reinforcing rose liner 21 on an inner side of the door plank 4. Subsequently, the first screw members 25 correspondingly extent through the holes 211 of the reinforcing rose liner 21, and engage with the screw holes of the assembling posts 321 of the outer lever assembly 3 so that the reinforcing rose liner 21 and the combination of the reinforcing rose liner 31 with the outer mounting rose 32 are mounted on either side of the door plank 4. The inner mounting rose 22 is disposed on an outer surface of the reinforcing rose liner 21. To mount the inner mounting rose 22, the second screw members 26 successively extend through the holes 221 of the inner mounting rose 22 and the screw holes 212 of the reinforcing rose liner 21; and the distal sharpened tips of the second screw members 26 even drill through the surface of the door plank 4 in the event. Consequently, the reinforcing rose liner 21 and the inner mounting rose 22 are mounted on the door plank 4. Advantageously, the second screw members 26 can avoid occurrences of displacement, rotational movements and vibrations of the latch bolt actuating unit 1. Finally, the inner rose escutcheon 23 and the inner lever 24 are assembled on the inner tubular member 11 while the outer rose escutcheon 33 and an outer lever 34 are assembled on the outer tubular member 12.

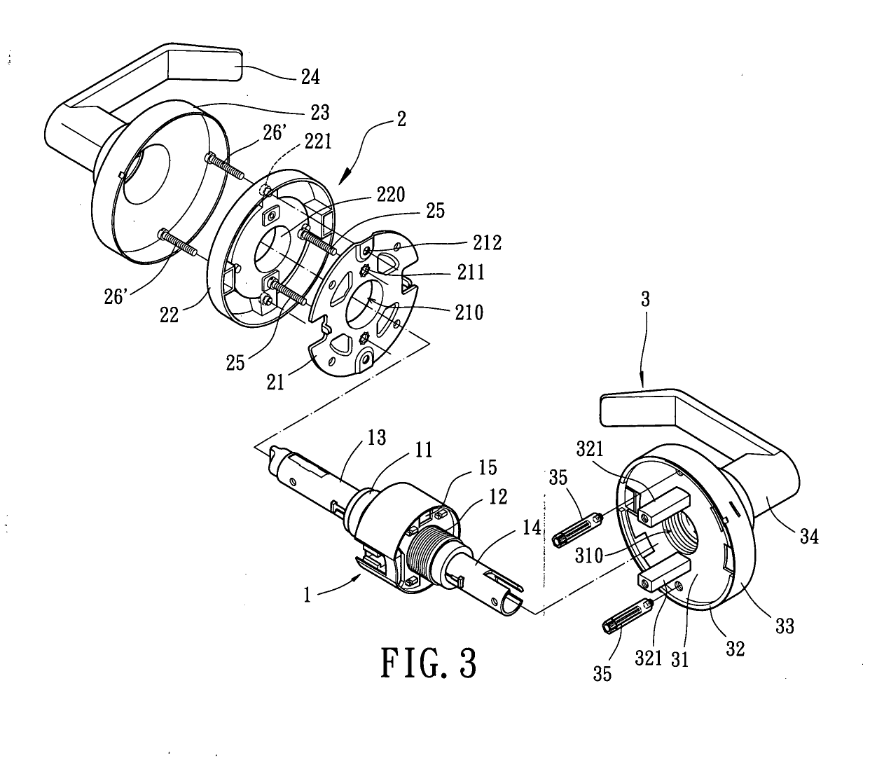

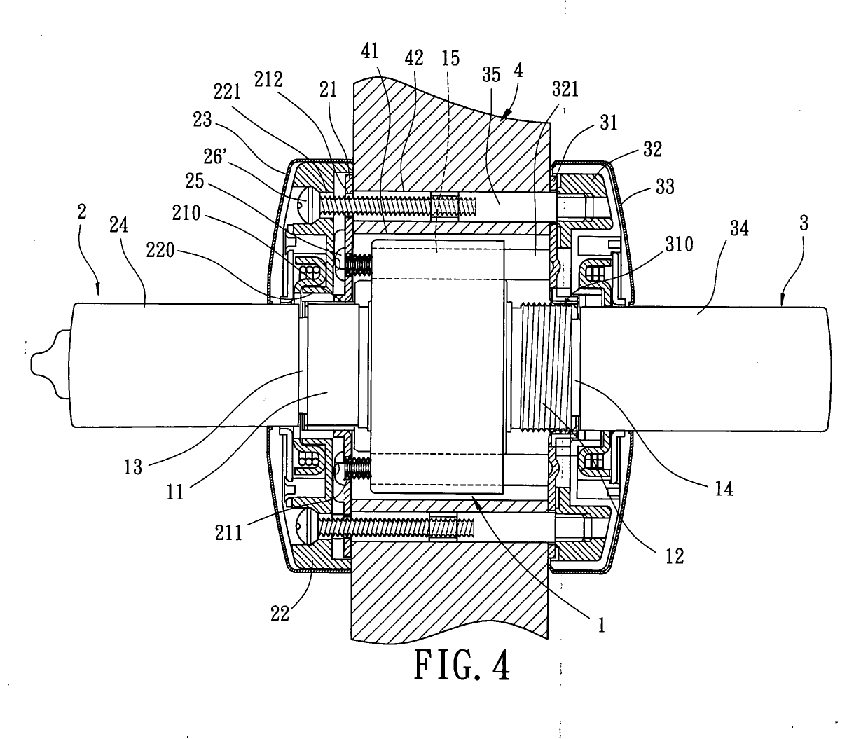

Turning now to FIGS. 3 and 4, views of the positioning structure for the door lock mechanism in accordance with a second embodiment of the present invention are illustrated. Reference numerals of the second embodiment of the present invention have applied the identical numerals of the first embodiment. The construction of the door lock mechanism in accordance with the second embodiment of the present invention has similar configuration and same function as that of the first embodiment and detailed descriptions may be omitted.

In comparison with the first embodiment, the second screw members 26 of the second embodiment directly mount the reinforcing rose liner 21 and the inner mounting rose 22 on the door plank 4. In the second embodiment, the door plank 4 provides at least two auxiliary positioning holes 42. Correspondingly, the outer lever assembly 3 provides a pair of detachable rods 35 which are mounted to the reinforcing rose liner 31 by means of screw connection. In an alternative embodiment, the detachable rods 35 are mounted to the outer mounting rose 32 by means of screw connection. Each distal end of the detachable rods 35 is provided with a screw bore to receive the second screw member 26′. In installing operation, the second screw members 26′ successively extend through the holes 221 of the inner mounting rose 22, the screw holes 212 of the reinforcing rose liner 21 and auxiliary positioning holes 42 of the door plank 4; and engage in the screw bores of the detachable rods 35. Advantageously, the second screw members 26′ can avoid occurrences of displacement, rotational movements and vibrations of the latch bolt actuating unit 1.

Preferably, the second screw members 26′ can be engaged in the screw holes 212 of the reinforcing rose liner 21 to mount the inner mounting rose 22 before installation. In installing or reinstalling operation, it is easy to assemble and disassemble the inner mounting rose 22 on the door plank 4 if the reinforcing rose liner 21 and the inner mounting rose 22 are properly assembled.

By referring to FIGS. 1 through 4, in the first embodiment, the engagement of the screw members 26 with the screw holes 212 of the reinforcing rose liner 21 can achieve a good reliability of the assembled relationship of the door lock mechanism. In the second embodiment, the engagement of the screw members 26′ with the screw bores of the detachable rods 35 within the auxiliary positioning holes 42 of the door plank 4 can also achieve a good reliability of the assembled relationship of the door lock mechanism.

It will be apparent from the aforementioned discussions that the conventional cylindrical lock assembly necessitates prefabrication of the positioning holes on the door plank due to no engagement of the screw member with the hole of the rose liner. Conversely, as best shown in FIGS. 1 and 2, the engagement of the screw members 26 with the screw holes 212 of the reinforcing rose liner 21 can avoid occurrences of displacement, rotational movements and vibrations of the latch bolt actuating unit 1 on the door plank 4.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A positioning structure for a door lock mechanism, comprising:
a latch bolt actuating unit received in a lock bore of a door plank;
a first lever assembly combined with a first side of the latch bolt actuating unit, the first lever assembly including a first reinforcing rose liner and a first mounting rose, each of the first reinforcing rose liner and the first mounting rose having at least two holes, the first reinforcing rose liner further including at least two screw holes each of which providing with an inner threaded portion;
a second lever assembly combined with a second side of the latch bolt actuating unit;
at least two first screw members extending through the holes of the first reinforcing rose liner of the first lever assembly, and then connecting with the second lever assembly; and
at least two second screw members extending through the holes of the first mounting rose of the first lever assembly, characterized in that each of the second screw members engaging with the screw holes of the first reinforcing rose liner of the first lever assembly by means of screw connection, and engaging on the door plank.

2. The positioning structure for the door lock mechanism as defined in claim 1, wherein the second screw member is processed in a procedure of carburizing, quenching or both.

3. The positioning structure for the door lock mechanism as defined in claim 1, wherein the second screw member has a distal sharpened tip to slightly engage in a surface of the door plank.

4. The positioning structure for the door lock mechanism as defined in claim 1, wherein the second lever assembly includes a second reinforcing rose liner and a second mounting rose.

5. The positioning structure for the door lock mechanism as defined in claim 4, wherein at least two assembling posts are formed on the second mounting rose of the second lever assembly, the assembling posts are successively extending through holes of the second reinforcing rose liner and through holes of the latch bolt actuating unit to engage with the first screw members.

6. The positioning structure for the door lock mechanism as defined in claim 5, wherein the assembling posts are integrally or separately formed on a surface of the second mounting rose of the second lever assembly.

7. The positioning structure for the door lock mechanism as defined in claim 1, wherein the latch bolt actuating unit is provided with a first tubular member and a second tubular member on the first side and the second side, and one of the first tubular member and the second tubular member is provided with an outer threaded portion to connect with an inner threaded portion of one of the first lever assembly and the second lever assembly.

8. The positioning structure for the door lock mechanism as defined in claim 1, wherein each of the first and second lever assemblies further includes a rose escutcheon and a lever.

9. A positioning structure for a door lock mechanism, comprising:
a latch bolt actuating unit received in a lock bore of a door plank;
a first lever assembly combined with a first side of the latch bolt actuating unit, the first lever assembly including a first reinforcing rose liner and a first mounting rose, each of the first reinforcing rose liner and the first mounting rose having at least two holes, the first reinforcing rose liner further including at least two screw holes each of which providing with an inner threaded portion;
a second lever assembly combined with a second side of the latch bolt actuating unit, the second lever assembly including a second reinforcing rose liner and at least two detachable rods mounted thereon;
at least two first screw members extending through the holes of the first reinforcing rose liner of the first lever assembly, and then connecting with the second lever assembly; and
at least two second screw members extending through the holes of the first mounting rose of the first lever assembly, characterized in that each of the second screw members engaging with the screw holes of the first reinforcing rose liner of the first lever assembly by means of screw connection, and engaging in a screw bore of the detachable rod of the second lever assembly within an auxiliary positioning hole of the door plank.

10. The positioning structure for the door lock mechanism as defined in claim 9, wherein the second screw member is processed in a procedure of carburizing, quenching or both.

11. The positioning structure for the door lock mechanism as defined in claim 9, wherein the second lever assembly further includes a second mounting rose.

12. The positioning structure for the door lock mechanism as defined in claim 11, wherein at least two assembling posts are formed on the second mounting rose of the second lever assembly, the assembling posts are successively extending through holes of the second reinforcing rose liner and through holes of the latch bolt actuating unit to engage with the first screw members.

13. The positioning structure for the door lock mechanism as defined in claim 12, wherein the assembling posts are integrally or separately formed on a surface of the second mounting rose of the second lever assembly.

14. The positioning structure for the door lock mechanism as defined in claim 9, wherein the latch bolt actuating unit is provided with a first tubular member and a second tubular member on the first side and the second side, and one of the first tubular member and the second tubular member is provided with an outer threaded portion to connect with an inner threaded portion of one of the first lever assembly and the second lever assembly.

15. The positioning structure for the door lock mechanism as defined in claim 9, wherein each of the first and second lever assemblies further includes a rose escutcheon and a lever.
